(19) United States
(12) Patent Application Publication
(10) Pub. No.: US 2004/0124332 A1
(43) Pub. Date: Jul. 1, 2004

(54) Vibration proof device for control units of electric drive units

(75) Inventors: Masayuki Takenaka, Anjo-shi (JP); Tomotaka Murakami, Anjo-shi (JP)

Correspondence Address: OLIFF & BERRIDGE, PLC, P.O. BOX 19928, ALEXANDRIA, VA, 22320, US

(73) Assignee: AISIN AW CO., LTD., Anjo-shi (JP)

(21) Appl. No.: 10/714,642

(22) Filed: Nov. 18, 2003

(30) Foreign Application Priority Data
Dec. 27, 2002 (JP) 2002-380172

(51) Int. Cl. F16M 1/00

(52) U.S. Cl. 248/648

(57) ABSTRACT

A control unit section made integral with an electric drive unit is improved in vibration resistance performance. In an electric drive unit, with which a control unit section of the drive unit provided with an electric motor is mounted on and made integral, the control unit section comprises power units and a control unit. The power units are immovably fixed to the drive unit, and the control unit is movably supported on the drive unit through a vibration proof support device. Thus, a control board in the form of a thin plate that is liable to generate membrane vibrations is provided whereby the control unit susceptible to vibrations is enhanced in vibration resistance performance to enable making the control unit section vibration proof in structure.

This application claims priority from Japanese Patent Application No. 2002-380172 filed Dec. 27, 2002, the disclosure of which is incorporated herein by reference thereto.

### BACKGROUND OF THE INVENTION

1. Field of Invention

The invention relates to a control unit of a drive unit, which takes power from an electric motor, and more particularly, to a control unit used in drive units for electric vehicles and drive units for hybrid vehicles.

2. Description of Related Art

In recent years, electric drive units have been developed in which a control unit section, composed of an inverter for control of an electric motor (in the specification, a motor and a generator actuated also as a motor are generically designated an electric motor) and a control device for integrated-control of the inverter and the drive unit are mounted on a drive unit casing. The drive unit casing receives therein the electric motor. In the case where a drive unit uniting therewith such a control unit section is mounted on a vehicle, in particular, in an engine compartment of the vehicle, various restrictions, in terms of mounting, are generated around an inverter although the control unit section is unequivocally united. For example, the need to ensure a crushable zone in a longitudinal direction of the vehicle, the presence of side members in a lateral direction of a vehicle, and the like come under such restrictions. Herebefore, there has been proposed a drive unit, in which a control unit section, including an inverter and so on, is arranged to extend in an upward direction of a vehicle, in which restrictions are relatively small, from the drive unit.

As described in JP-A-2001-119898, a control unit section of the drive unit is structured such that switching element power modules of an inverter are fixed to a bottom of an inverter casing, which is fixed to a top of a drive unit casing and in the form of a bottomed, rectangular cylinder. Smoothing capacitors annexed to the inverter are mounted on a mount, which projects from an intermediate portion of a cylindrical drum of a casing frame, through a bracket. Further, a control board is fixed to a top wall of the drum.

Applicants believe that when positioning of the control unit section relative to the drive unit for uniting therewith is appropriate as such, vibration resistance, or shock resistance, of the electronic parts as mounted is a concern as the control unit section is exposed to vibrations during running of a vehicle when it is envisioned that such a united structure is applied to electric vehicles. Also, when it is envisioned that such united structure is applied to hybrid vehicles, the control unit section is further exposed to engine vibrations, so that vibration resistance performance is a serious concern.

Further, that structure, in which a control board is arranged on a top of a control unit section, results in the control board, which has a small flexural rigidity, is fixed only at its peripheral edge to a frame because support for the topmost parts can be provided only around the drum by the structure of the casing frame. Further, Applicants fear that membrane vibrations can possibly be generated to adversely affect control because a central portion in such a structure is liable to flex due to vibrations or the like.

### SUMMARY OF THE INVENTION

The invention is to address such a situation and has its object to improve a control unit section, which is united with an electric drive unit, in vibration resistance performance.

In order to attain the above object, as embodied, the invention provides a vibration proof device for control units of electric drive units, in which a control unit section of a drive unit provided with an electric motor is mounted on the drive unit to be united therewith, the control unit section comprising a power unit and a control unit, the power unit being immovably fixed to the drive unit, and the control unit being movably supported on the drive unit through a vibration proof mechanism.

In the above structure, it is effective that the power unit comprises an inverter unit, the inverter unit is connected to the electric motor of the drive unit through a connection member, and the connection member is immovably fixed to the drive unit and the power unit. Also, it is effective that the power unit comprises an inverter unit, the control unit section is provided with a casing, which receives therein at least the inverter unit, and the power unit is held on the casing. In this case, the casing is fixed to the drive unit to thereby make the power unit immovable relative to the drive unit.

Also, a structure is made possible, in which the control unit is supported through the vibration proof mechanism on the power unit and supported through the power unit on the drive unit. In this case, it is effective that the control unit comprises a control board fixed to a base to control the drive unit, and the base is supported through the vibration proof mechanism on the drive unit. Alternatively, a structure is made possible, in which the control unit is fixed to a cover of a frame, which receives therein the control unit section, and the cover is supported through the vibration proof mechanism on the drive unit. In these cases, a flexible grounding member grounds the control unit to the drive unit.

In the case where the drive unit is a hybrid drive unit connected to and united with an internal combustion engine, it is effective that the vibration proof mechanism is made of a vibration proof material and has a resonance frequency, which is at least a primary frequency of the chamber combustion of the internal combustion engine and at most a resonance frequency of the control board.

With the structure of a first aspect, because it is possible to vibro-isolatingly support the control unit having a control board, which is in the form of a thin plate liable to flexing as compared with other parts constituting the control unit section, and to generate membrane vibrations upon resonance when vibrations are applied, the control unit section can be improved in vibration resistance performance.

Subsequently, with the structure of a second aspect, because the inverter unit and the connection member for connection thereof with the electric motor are put in an immovable relationship with the drive unit and the power unit, there is no need of making connection to the electric motor, for which a large current is used, flexible, so that the structure is made simple.

Also, with the structure of a third aspect, because the power unit can be united with the drive unit, in a state in which the inverter unit is received in the casing of the control unit section, the control unit section can be handled with ease.

Also, with the structure of a fourth aspect according to the invention, because the power unit is immovably fixed to the casing by simply fixing the control unit section to the drive unit, it is improved in assembling property.

Subsequently, with the structure of a fifth aspect, the control unit section can be improved in vibration resistance performance while it is made compact by stacking the power unit and the control unit when assembled.

Also, with the structure of a sixth aspect, because the control board, which is in the form of a thin plate liable to flexing as compared with other parts constituting the control unit section and to generating membrane vibrations upon resonance when vibrations are applied, is fixed to the base to provide high rigidity using the rigidity of the base, the control unit section can be improved in vibration resistance performance. Also, even when the control unit section vibrates, the vibration proof material can damp propagation of vibrations to the control board, so that the control unit section can be improved as a whole in vibration resistance performance by protecting the control board that is susceptible to vibrations.

Also, with the structure of a seventh aspect, because the control unit section including the control board, which is in the form of a thin plate liable to flexing as compared with other parts in the control unit section and to generating membrane vibrations upon resonance when vibrations are applied, is fixed to the cover to provide high rigidity using the rigidity of the cover, the control unit can be improved in vibration resistance performance. Also, even when the control unit section vibrates, the vibration proof material can dampen the propagation of vibrations to the control board, so that the control unit section can be improved as a whole in vibration resistance performance by protecting the control board that is susceptible to vibrations.

Also, with the structure of a eighth aspect, the control unit can be surely grounded to the drive unit without impeding the vibration proof property of the control unit.

Also, with the structure of a ninth aspect, while the vibration proof support means is made up of a simple vibration proof material, its size can be set appropriately in order to allow fixation with common fixation means, such as bolting or the like, as compared with such a size, that is very small, where setting of the vibration frequency is made lower than the vibration frequency at the time of idling of the engine.

### BRIEF DESCRIPTION OF THE DRAWINGS

The invention will be described with reference to the drawings, in which:

FIG. 1 is a block diagram showing a system structure of a drive unit for hybrid vehicles according to the invention;

FIG. 2 is an axial, partial, cross sectional view showing the drive unit for hybrid vehicles, with which a control unit section is made integral;

FIG. 3 is a partially exploded, perspective view showing the control unit section; and

FIG. 4 is an axial, partial, cross sectional view showing that drive unit for hybrid vehicles, with which a control unit section is made integral, according to another embodiment.

### DETAILED DESCRIPTION OF PREFERRED EMBODIMENTS

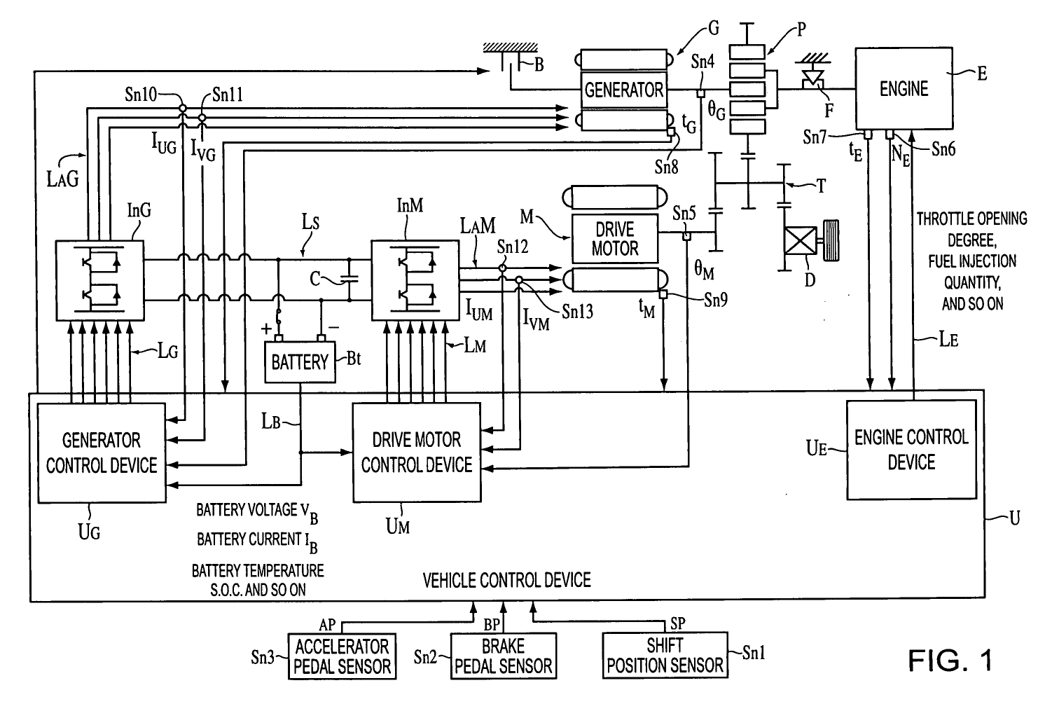

FIG. 1 shows, in block diagram, the system structure of a drive unit for hybrid vehicles. The drive unit has as its main components a generator G arranged on a first axis, a drive motor M arranged on a second axis, a differential D arranged on a fourth axis, and a planetary gear set P arranged on the first axis and composed of a single pinion. An internal combustion engine (referred below to as engine) E coupled to the planetary gear set P on the first axis and the generator G coaxial with the engine E are drivingly connected to each other via the planetary gear set P. The engine E and the generator G are drivingly connected to the differential D via a counter gear mechanism T on a third axis. The driving motor M is directly connected to the differential D via the counter gear mechanism T. Further, a one-way clutch F for preventing reverse rotation of the engine E and a brake B for preventing idling of the generator G are also included in the drive unit.

A vehicle control system of the drive unit includes a vehicle control device U, that mainly composes the vehicle control system, a shift position sensor Sn1, a brake pedal sensor Sn2 and an accelerator pedal sensor Sn3, as means for inputting a driver's demands to the vehicle control device, various sensors (a generator rotor position sensor Sn4, drive motor rotor position sensor Sn5, or the like) as means for the input of various information with respect to running conditions of the vehicle, a battery Bt as a power source, a drive motor inverter InM as means for driving the drive motor M, and a generator inverter InG for driving the generator G.

The vehicle control device U, having a CPU, a memory, and so on, serves as a control device for controlling the entire vehicle, and is provided with an engine control device U_{E}, a generator control device U_{G}, and a drive motor control device U_{M}. The engine control device U_{E} has a CPU, a memory, and so on, and is connected via a signal line L_{E} to the engine E to forward command signals, such as a throttle opening, a fuel injection quantity, or the like, to control the engine E. Also, the generator control device U_{G} has a CPU, a memory, and so on, and is connected via a signal line L_{G} to the inverter InG to forward a control signal to the inverter InG to control the generator G, which is composed of a three-phase AC motor (for example, a permanent magnet type synchronous motor). Also, the drive motor control device U_{M} is connected via a signal line L_{M} to the inverter InM to forward a control signal to the inverter InM to control the drive motor M, which is composed of a three-phase AC motor. Both inverters InG, InM are connected via a DC power line L_{S} to the battery Bt and connected via three-phase (three phases of U, V, W) AC power lines L_{A}G, L_{A}M to three-phase coils of respective stators of the drive motor M and the generator G. In addition, the character C denotes a smoothing capacitor for suppressing fluctuation of DC voltage in the DC power line L_{S} to smoothen the same.

In greater detail, the inverter InG is controlled on the basis of a PWM (pulse width modulation) signal output to the signal line L_{G} by the generator control device U_{G}, and converts a DC current fed via the DC power line L_{S} from the battery Bt into currents I_{UG}, I_{VG}, I_{WG} of respective phases U, V, W at the time of power running to forward the respective currents I_{UG}, I_{VG}, I_{WG} to three-phase coils of the generator G via the three-phase AC power line L_{A}G. Also, at the time of generation or regeneration, the currents I_{UG}, I_{VG}, I_{WG} of the respective phases U, V, W generated in the three-phase coils of the generator G are supplied via the three-phase AC power line L_{A}G to be converted into DC currents to be forwarded to the battery Bt via the DC power line L_{S}.

Also, the inverter InM is controlled on the basis of a control signal output to the signal line L_{M} by the drive motor control device U_{M}, and converts a DC current fed via the DC power line L_{S} from the battery Bt into currents I_{UM}, I_{VM}, I_{WM} of the respective phases U, V, W at the time of power running to forward the respective currents I_{UM}, I_{VM}, I_{WM} to three-phase coils of the drive motor M via the three-phase AC power line L_{A}M. Also, at the time of generation or regeneration, the currents I_{UM}, I_{VM}, I_{WM} of the respective phases U, V, W generated in the three-phase coils of the drive motor M are supplied via the three-phase AC power line L_{A}M to be converted into DC currents to be forwarded to the battery Bt via the DC power line L_{S}.

Among the various sensors, a battery sensor (not shown) on a signal line L_{B} detects a condition of the battery Bt, that is, battery voltage (V_{B}), battery current (I_{B}), battery temperature, battery residual quantity (SOC: state of charge), and so on, and inputs such information into the generator control device U_{G} and the drive motor control device U_{M}. The engine speed sensor Sn6 detects an engine speed (N_{E}). The shift position sensor Sn1 detects a shift position (SP) of selective speed operation means (not shown). The accelerator pedal sensor Sn3 detects a position of an accelerator pedal, that is, a stepping-on quantity (AP). A brake pedal sensor Sn2 detects a position of a brake pedal, that is, a stepping-on quantity (BP). An engine temperature sensor Sn7 detects a temperature (t_{E}) of the engine E. A generator temperature sensor Sn8 detects a temperature (t_{G}) of the generator G from, for example, a temperature of the coil. A drive motor temperature sensor Sn9 detects a temperature (t_{M}) of the drive motor M from, for example, a temperature of the coil. Respective current sensors Sn10 to Sn13 of the three-phase AC power lines L_{A}G, L_{A}M serve as current sensors for detecting current values of two phases among three phases, that is, I_{UG}, I_{VG}, I_{UM}, I_{VM}.

Thus, the vehicle control device U executes various arithmetic processings, such as forwarding an engine control signal to the engine control device U_{E} to set driving/stoppage of the engine E, reading a rotor position (θ_{G}) of the generator G to calculate a rotational frequency of the generator, reading a rotor position (θ_{M}) of the drive motor M to calculate a rotational frequency of the drive motor, calculating an engine speed on the basis of the relationship therebetween, setting a target engine speed in the engine control device U_{E} to represent a target value of engine speed, setting a target rotational frequency of the generator and a target torque of the generator in the generator control device U_{G}, setting a target torque of the drive motor and a correction value of torque of the drive motor in the drive motor control device U_{M}, or the like.

Also provided on the drive unit are a hydraulic circuit, for hydraulic control of the brake B of the gear train and lubrication and cooling of respective mechanisms, and a hydraulic circuit device, for control of the hydraulic circuit, which are not shown. In relation to the above, the vehicle control device U includes a memory information for controlling the hydraulic circuit device by means of control with a solenoid signal, and arithmetic processing means.

As understood from the system structure, while both inverters InG, InM and the smoothing capacitor C common thereto, in addition to the vehicle control device U, can be said in a broad sense to functionally constitute a conceptional control device for the drive unit, both inverters InG, InM are interposed on the power lines to be controlled by the generator control device U_{G} and the drive motor control device U_{M}, and the smoothing capacitor C is an element likewise interposed on the power lines, so that a substantial unit making-up the vehicle control device U for genuinely executing a signal control is defined to make-up a control device in a narrow sense and is called a control unit, the inverter units constituting both inverters InG, InM are called a power unit inclusive of a unit composed of the smoothing capacitor C, and all these units are generally called a control unit section.

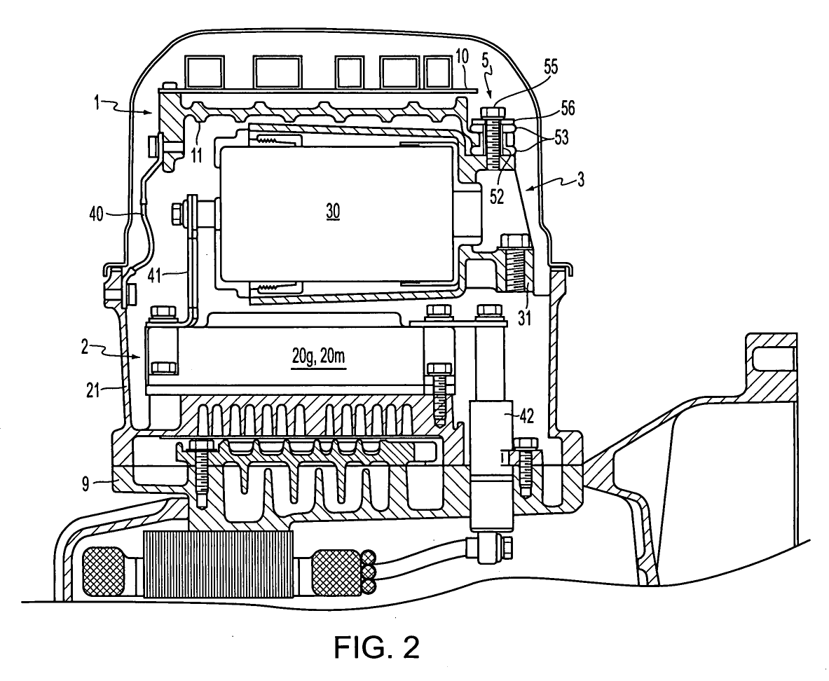

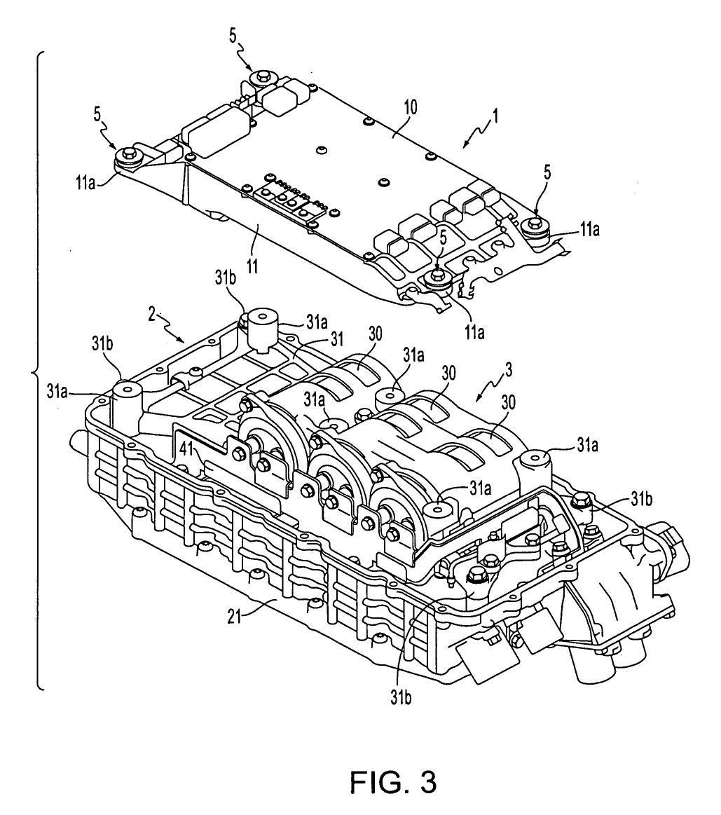

FIG. 2 is an axial, partial, cross sectional view showing the structure of the drive unit, and FIG. 3 is a partially exploded, perspective view showing the structure of the control unit section, which is composed of a control unit 1, an inverter unit 2, and a capacitor unit 3 in this embodiment. The control unit 1 includes an electronic control unit (ECU) mainly composed of a memory for storing various programs for control of the control device and data, and a microcomputer. Structurally, it comprises a control board 10 containing various functional chips arranged in a circuit and a bracket 11 as a base mounting the functional chips thereon. The inverter unit 2, which constitutes switching circuits for the both inverters InG, InM, comprises switching element power modules 20g, 20m for the generator G and the drive motor M, composed of circuit boards with switching transistors and accompanying circuit chips thereon, and a base 21 mounting them thereon. Smoothing capacitors 30, in a DC circuit section, are positioned separated from and connected to the modules 20g, 20m through a bus panel 41, and mounted on a separate bracket 31 to make the capacitor unit 3. The inverter unit 2, the capacitor unit 3, and the control unit 1 are mounted in the order given on a drive unit casing 9, which stores therein the generator G, the drive motor M, the planetary gear set P, the differential D, the counter gear mechanism T, the brake B, and the one-way clutch F, shown in FIG. 1.

A frame 21, as a base for the inverter unit 2, is made of a casting of an aluminum material for heat dissipating and lightweight purposes. The frame 21 has a substantially box-shaped structure with a bottom, and limited height (or low) side walls, in which the two switching element power modules 20g, 20m are arranged adjacent to each other (the modules are arranged in a direction parallel to the plane of FIG. 2 and overlapping one another, so the characters denoting them are written together on the one of the modules shown). Terminals 42, as the six connection members for connection of the three-phase AC power lines L_{A}G, L_{A}M (see FIG. 1) are arranged in parallel to and on a side of the modules. Boss portions 31a, formed with threaded holes, are provided at four comers of the frame 21 and centrally of a side of the three-pole AC terminals 42, and serve as a mount for the bracket 31, which serves as a mount base for the smoothing capacitors 30.

The switching element power modules 20g, 20m are brought into close contact with a machined surface on an upper surface of a heat sink formed integral with a raised bottom wall of the casing frame 21. The casing frame 21 stores therein the switching element power modules 20g, 20m. The switching element power modules 20g, 20m are fixedly bolted directly to the machined surface to ensure a maximum surface contact.

In order to contact the switching element power modules 20g, 20m with the heat sink, which is provided by the bottom wall of the casing frame 21, to cool the switching element power modules 20g, 20m, because the switching element power modules use of large currents generate a large quantity of heat due to their electrical composition, the control unit section in this embodiment is constructed to align and arrange the switching element power modules 20g, 20m on the bottom wall in a lowermost area of the control unit section, arrange thereabove the capacitors 30 for the smoothing circuits of the inverters as described above, and further arrange thereabove the control board 10. The smoothing capacitors 30 and the control board 10 extend above the casing frame 21, and so a cover expanding upward in a manner to cover these elements covers an upper portion of the casing frame 21.

The arrangement adopts a system of circulating an ATF (automatic transmission fluid) within the drive unit casing 9 for the purpose of lubrication of the respective mechanisms of the drive unit and for cooling the drive motor M and the generator G. The ATF is cooled by means of heat exchange with a separate coolant (for example, water, anti-freeze solution, or the like is used therefor). A system of arranging the control unit section integrally on the drive unit and cooling the same by means of heat exchange with a coolant, so that a flow space for the ATF and the coolant, which contact with each other through a heat transfer wall provided with radiating fins, is defined in a connection of the drive unit and the control unit section.

In this embodiment, three smoothing capacitors 30 are provided and arranged to align laterally of the bracket 31. The bracket 31 is substantially plate-shaped with a ribbed structure for heat dissipation, lightweight, and high rigidity. The bracket 31 is further formed with a smoothing capacitor storage portion, which is configured to extend upward from a plate surface and to assume the shape of a horizontal cylinder. The horizontal cylinder is provided at each of the four comers and the bracket 31 has clamp portions 31b associated with the horizontal cylinders. The clamp portions 31b are formed with bolt insertion holes positioned to correspond to the mounts of the frame 21. Also, six upwardly extending boss portions 31a are provided, a boss portion 31a at each of the four corners to the inside of the clamp portions 31b and in two locations substantially intermediate the four corners. The boss portions 31a are formed with threaded holes to serve as a mount for the control unit 1. The respective smoothing capacitors 30 are fitted into the storage portion of the bracket 31 thus structured, and latched and fixed by bolting stops attached to end surfaces of the terminals to the bracket 31.

The control board 10 is fixed, by screws, to an upper surface of the bracket 11. The bracket 11 is substantially plate-shaped and has a ribbed structure, for heat dissipation, lightweight, and high rigidity in the same manner as the bracket 31. Clamp portions 11a for vibration proof support means 5, are provided at four corners of the bracket 11 in a positional relationship to correspond to the portions 31a of the bracket 31, to which the smoothing capacitors 30 are mounted. The portions of the bracket 11, to which the control board 10 is attached, project somewhat from the upper surface of the bracket 11. These boss portions are provided at substantially constant intervals, at fourteen locations (indicated by the positions of screw heads in FIG. 3) in the lengthwise and crosswise directions. Two separate clamp portions (covered by the control board 10 in FIG. 3) are provided in positions clear of the boss portions to be put in a positional relationship to correspond to the mounts 31a of the bracket 31. The vibration proof support means 5 are arranged on the clamp portions 11a in a total of six locations. That is, the control unit 1 is supported through the vibration proof support means 5 on the drive unit. In addition, the drive unit, to which the vibration proof support means 5 is mounted, in the invention does not necessarily mean only a body of a drive unit in a strict sense but includes those members which are fixed integrally to the control device and can serve as an intermediate member for support, even if such members are on a side of the control unit section as in this embodiment.

The control unit 1 is supported through the vibration proof support means 5 on the drive unit. In this embodiment, the control unit 1 is fixed to the power units 2, 3 through the vibration proof support means 5 and supported, through the power units 2, 3, on the drive unit. As described above, the control unit 1 is fixed to the bracket 11, the bracket 11 providing a base for the control board 10. The bracket 11 is supported through the vibration proof support means 5 on the drive unit.

In this embodiment, because the vibration proof support means 5 is composed of elastic bodies 53 made of vibration proof materials, such as rubber or the like, and the drive unit is a hybrid drive unit connected integrally to the engine E (see FIG. 1), the resonance frequency of the elastic bodies 53 is at least a primary frequency of engine cylinder firing and at most a resonance frequency of the control board 10. Because the elastic bodies 53 are thus composed of an insulating material, such as rubber or the like, to thereby make grounding at the clamp portions impossible, grounding of the control unit 1 to the drive unit is made by a multiplicity of separate grounding conductors 40 for connection of the base 11 and the frame 21. The grounding conductors 40 are composed of a metallic mesh wire, for example, litz wire formed by braiding copper wires as there is a need for flexibility to allow relative movement between the connections at both ends without resistance and grounding, which is stable and small in grounding resistance.

Stated in more detail, the vibration proof support means 5 comprises a collar 52 fitted on an outer periphery of a clamp bolt 55, a cushioning member composed of vibration proof material to provide an elastic body 53 made of rubber or the like, the elastic body 53 having a cylindrical-shaped portion having an inside diameter fitted onto an outer periphery of the collar 52 and an outside diameter fitted into a mount hole formed on the clamp portion 11a of the bracket 11 and a pair of flanges extending radially outward from both ends of the cylindrical-shaped portion, and a flat washer 56 to abut against an end surface of the collar 52. In addition, an upper flange of the elastic body 53 is formed separate from the remaining portion for the purpose of ease in assembly.

The vibration proof support means 5 thus structured is fixed in a state, in which clamping of the clamp bolt 55 brings both ends of the collar 52 into pressure contact with the bracket 31 and the flat washer 56. Such bolting causes the elastic body 53 to be axially compressed in an appropriate loading condition between the boss portions 31a of the bracket 31 and the flat washers 56, whereby the bracket 11 is elastically supported on the bracket 31 by compressive forces of the pair of flanges of the elastic body 53.

When a vibrating load is applied in this state, the phase difference in vibration between the drive unit and the control unit 1 causes the bracket 11 to move axially relative to the bracket 31. During this movement, the load energy is absorbed as energy by compression by one of the pair of flanges of the elastic body 53 and elongation of the other of the pair of flanges.

As described above in detail, the control unit section can be improved in vibration resistance performance according to the embodiment because it is possible to vibro-isolatingly support the control unit 1, having the control board 10, which is plate-shaped and liable to flexing as compared with other parts of the control unit section and liable to generate membrane vibrations due to resonance when vibrations are applied.

Also, the control unit section can be improved in vibration resistance performance while the control unit section is made compact by a structure stacking the power units 2, 3 and the control unit 1.

Also, because the control board 10, which is plate-shaped and liable to flexing as compared with other parts of the control unit section and liable to generate membrane vibrations due to resonance when vibrations are applied, is fixed to the base 11 to increase rigidity by using the rigidity of the base 11, the control unit 1 can be improved in vibration resistance performance. Also, even when the control unit section vibrates, the elastic bodies 53 can damp propagation of vibrations to the control board 10, so that the control unit section can be improved as a whole in vibration resistance performance by protecting the control board 10 susceptible to vibrations for the above reason.

Also, while the vibration proof support means 5 is comprised of the simple vibration proof material of the elastic bodies 53, its size can be set appropriately in order to allow fixation by bolting, as compared with such a size, that is very small, where setting of the vibration frequency is made lower than the vibration frequency at the time of idling of the engine.

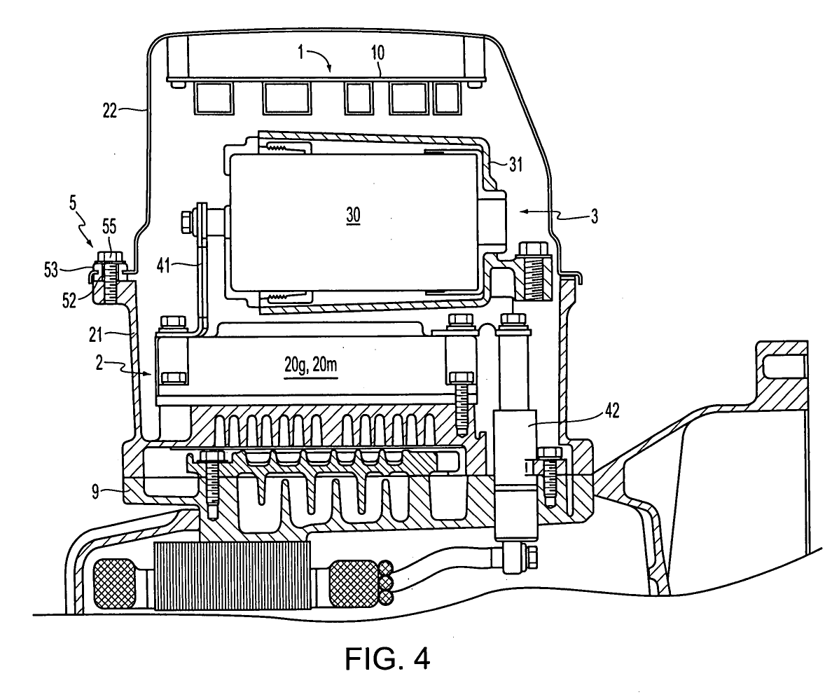

With the described embodiment, the control unit 1 is vibro-isolatingly supported on the bracket 31 and hence on the drive unit, that is, on the drive unit casing 9 through the bracket 31 and the casing frame 21, but vibro-isolating support of the control unit 1 can be made by means of other members. Such an embodiment is shown in FIG. 4. In FIG. 4, the control unit 1 is fixed to the cover 22 of the frame 21, which receives therein the control unit section. The cover 22 is vibro-isolatingly supported on the frame 21, with the result that the control unit 1 is vibro-isolatingly supported on the drive unit.

In this case, the board 10 of the control unit 1 is fixed directly to the cover 22, by screws for example, without the medium of any base. The vibration proof support means 5 is arranged making use of a bolt clamp on a seal member inserted between mating surfaces of the cover 22 and the casing frame 21. In this case, an elastic body 53, of a vibration proof material of the vibration proof support means 5 is configured to comprise an annular thick-wall portion, an outer peripheral groove of which is fitted into a bolt insertion hole of the cover 22 in a bolt clamp position, and a collar 52 is fitted into a hole of the thick-wall portion. With the vibration proof support means 5, the elastic body 53 is placed in a predetermined state of compression by bolting, by which the annular thick-wall portion is compressed between a flange portion of a flanged bolt 55 and a mating surface of the casing frame 21. The cover 22 is inserted into the elastic body 53 and supported in a floating position relative to the casing frame 21. In addition, grounding conductors in this embodiment are the same as those in the previous embodiment, and omitted from depiction.

Also, with this second embodiment, when a vibrating load is-applied, the phase difference in vibration between the drive unit and the control unit 1 causes the cover 22, which is made integral with the control unit 1, to move axially relative to the casing frame 21. During the axial movement, the load energy is absorbed as energy for compression by one of the pair of flanges of the elastic body 53 and elongation by the other of the pair of flanges.

The control unit section can be also improved in vibration resistance performance, according to this embodiment, because it is possible to vibro-isolatingly support the control unit 1 having the control board 10, which is plate-shaped and liable to flexing as compared with other parts of the control unit section and liable to generate membrane vibrations due to resonance when vibrations are applied. Because the control board 10, which is plate-shaped and liable to flexing as compared with other parts of the control unit section and liable to generate membrane vibrations due to resonance when vibrations are applied, is fixed to the cover 22 to obtain high rigidity by using the rigidity of the cover 22, the control unit 1 can be improved in vibration resistance performance. Also, although the vibration proof support means 5 is provided by the simple elastic body 53 made of vibration proof material, its size can be set appropriately to allow fixation by bolting, as compared with such a size, which is very small, where setting of the vibration frequency is made lower than the vibration frequency at the time of idling of the engine.

Although the invention has been described above in detail on the basis of the embodiments, in which the invention is applied to a drive unit for hybrid vehicles, the invention is not limited to such embodiments but may be applied to all drive units, such as electric vehicle or the like, in which at least an electric motor is used and its control unit section is made integral with a drive unit. Further, the invention can be put into practice while the structure is variously modified within the scope described in the claims such that in the case where a control unit and a power unit are integrally constructed, the vibration proof support means can be arranged on a mount of a drive unit and a control unit section, and in the case where a control unit is divided into a plurality of units for control of an engine and for control of an electric motor or the like, the vibration proof support means can be applied to every unit or a particular unit.

What is claimed is:

1. A vibration proof device for a control unit in which a control unit section of a drive unit provided with an electric motor is mounted on the drive unit to be united therewith, the control unit section, comprising:
a power unit; and
a control unit, the power unit being immovably fixed to the drive unit, and the control unit being movably supported on the drive unit using a vibration proof mechanism.

2. The vibration proof device for a control unit according to claim 1, wherein the power unit comprises an inverter unit, the inverter unit is connected to the electric motor of the drive unit through a connection member, and the connection member is immovably fixed to the drive unit and the power unit.

3. The vibration proof device for a control unit according to claim 2, wherein the power unit comprises an inverter unit, the control unit section is provided with a casing, which receives therein at least the inverter unit, and the power unit is held on the casing.

4. The vibration proof device for a control unit according to claim 3, wherein the casing is fixed to the drive unit to thereby make the power unit immovable relative to the drive unit.

5. The vibration proof device for a control unit according to claim 3, wherein the control unit is supported through the vibration proof mechanism on the power unit and supported through the power unit on the drive unit.

6. The vibration proof device for a control unit according to claim 3, wherein the control unit comprises a control board fixed to a base to control the drive unit, and the base is supported through the vibration proof mechanism on the drive unit.

7. The vibration proof device for a control unit according to claim 3, wherein the control unit is fixed to a cover of a casing of the control unit section, and the cover is supported through the vibration proof mechanism on the drive unit.

8. The vibration proof device for a control unit according to claim 2, wherein the control unit is supported through the vibration proof mechanism on the power unit and supported through the power unit on the drive unit.

9. The vibration proof device for a control unit according to claim 2, wherein the control unit comprises a control board fixed to a base to control the drive unit, and the base is supported through the vibration proof mechanism on the drive unit.

10. The vibration proof device for a control unit according to claim 2, wherein the control unit is fixed to a cover of a casing of the control unit section, and the cover is supported through the vibration proof mechanism on the drive unit.

11. The vibration proof device for a control unit according to claim 1, wherein the power unit comprises an inverter unit, the control unit section is provided with a casing, which receives therein at least the inverter unit, and the power unit is held on the casing.

12. The vibration proof device for a control unit according to claim 11, wherein the casing is fixed to the drive unit to thereby make the power unit immovable relative to the drive unit.

13. The vibration proof device for a control unit according to claim 11, wherein the control unit is supported through the vibration proof mechanism on the power unit and supported through the power unit on the drive unit.

14. The vibration proof device for a control unit according to claim 11, wherein the control unit comprises a control board fixed to a base to control the drive unit, and the base is supported through the vibration proof mechanism on the drive unit.

15. The vibration proof device for a control unit according to claim 11, wherein the control unit is fixed to a cover of a casing of the control unit section, and the cover is supported through the vibration proof mechanism on the drive unit.

16. The vibration proof device for a control unit according to claim 1, wherein the control unit is supported through the vibration proof mechanism on the power unit and supported through the power unit on the drive unit.

17. The vibration proof device for a control unit according to claim 1, wherein the control unit comprises a control board fixed to a base to control the drive unit, and the base is supported through the vibration proof mechanism on the drive unit.

18. The vibration proof device for a control unit according to claim 1, wherein the control unit is fixed to a cover of a casing of the control unit section, and the cover is supported through the vibration proof mechanism on the drive unit.

19. The vibration proof device for a control unit according to claim 1, wherein a flexible grounding member grounds the control unit to the drive unit.

20. The vibration proof device for a control unit according to claim 1, wherein the drive unit is a hybrid drive unit connected to and united with an internal combustion engine, and the vibration proof mechanism is made of a vibration proof material and has a resonance frequency, which is at least a primary frequency of the cylinder firing of the internal combustion engine and at most a resonance frequency of the control board.

21. A vibration proof mounting for a sensitive electronic device on a drive unit of a vehicle, the mounting comprising:
a base unit immovably mounted to the drive unit, the base unit having at least two boss portions, each boss portion having a hole therein; and
a mount assembly for each boss portion, the sensitive electronic unit having a hole passing therethrough aligned with the hole in each of the at least two boss portions, each mount assembly comprising:
a retainer that is received in a corresponding hole;
a collar surrounding a shaft of the retainer and seated on the base unit; and
one of a washer or a flange seated on an upper surface of the elastic body,
wherein when the retainer is attached, the one of the washer or the flange compresses the elastic body.

22. The vibration proof mounting according to claim 21, wherein the elastic body has a first ring like portion adjacent the one of the washer or flange and a second portion having a top-hat shape with a hold passing through the top hat to receive the collar.

23. The vibration proof mounting according to claim 21, wherein the elastic body is a single cylindrical structure with a hole to receive the collar.

24. The vibration proof mounting according to claim 21, wherein the at least two boss portions are four boss portions.

25. The vibration proof mounting according to claim 24, wherein the holes in the sensitive electronic unit are substantially at corners thereof and the boss portions are likewise substantially opposing the corners of the sensitive electronic unit.

26. The vibration proof mounting according to claim 25, wherein the base unit comprises at least one additional boss portion, in addition to the four boss portions, wherein the at least one additional boss portion is substantially symmetrically and centrally positioned relative to at least two of the four boss portions and the sensitive electronic unit has a hole corresponding to each additional boss portion of the at least one additional boss portion.
